(19) United States
(12) Patent Application Publication
(10) Pub. No.: US 2017/0032582 A1
(43) Pub. Date: Feb. 2, 2017

(54) INTEGRATED MOBILE PARKING AND ENFORCEMENT SYSTEM

(71) Applicant: Municipal Parking Services, Inc., Minnetonka, MN (US)

(72) Inventors: Mark J. MORAN, Woodbury, MN (US); Richard W. KELLEY, II, Corcoran, MN (US); David E. COLLINS, JR., Plymouth, MN (US); Steven B. LANE, Maple Grove, MN (US); Christopher W. BALDWIN, St. Paul, MN (US); Marcus N. SCHMIDT, Minnetonka, MN (US); John J. LEIER, Brooklyn Park, MN (US); Ian T. BUI, Bloomington, MN (US); Umarani PANDIAN, Durham, NC (US)

(21) Appl. No.: 15/223,144

(22) Filed: Jul. 29, 2016

Related U.S. Application Data
(60) Provisional application No. 62/199,135, filed on Jul. 30, 2015.

(51) Int. Cl. G07B 15/02; H04N 1/00; H04N 7/18; G06K 9/00; G06F 3/0482; G06F 17/24

(52) U.S. Cl. CPC G07B 15/02; G06F 3/0482; G06F 17/243; H04N 7/183; G06K 9/00771; H04N 1/00326; G06Q 50/18

(57) ABSTRACT

A software application executing on a parking enforcement officer's (PEO's) computing device (e.g. smart phone, tablet, laptop or personal computer) communicates with a central computing system networked with a plurality of smart parking meters, directs the PEO to the location of a violation, and facilitates generation of a parking citation to be issued by the PEO, wherein the citation has at least some of the data fields prefilled.

### PRIORITY

This application claims the priority benefit of U.S. Provisional Application No. 62/199,135, filed on Jul. 30, 2015, which is hereby incorporated herein by reference in its entirety.

### FIELD

The present invention relates generally to parking systems and, more particularly, to a parking enforcement system that is integrated with a plurality of smart parking meters.

### BACKGROUND

In order to issue a parking violation notice, citation or ticket to an illegally parked vehicle, a person authorized to issue parking citations (e.g. police officer or parking enforcement officer) must first determine whether a vehicle is deserving of a citation. In order to do this, the parking enforcement officer (PEO) must physically monitor vehicles and parking meters to determiner whether the parking time on a meter is expired. Then the PEO must fill out the parking citation and place it on the vehicle.

A given PEO cannot monitor all metered parking spaces in a given territory at the same time. Thus, the PEO typically travels a route through their territory and issues citations as the violations are observed. Naturally, parking violations will go uncited because the PEO was not in position to learn of the violation before the violating vehicle left the parking space or added more time to the expired meter. Even adding more PEOs cannot realistically allow for all metered parking spaces to be monitored simultaneously at all times. And adding more PEOs adds significant costs to the enforcement process.

Smart parking meter systems have been developed, such as those disclosed in U.S. Pat. Pub. Nos. 2014/0214499 A1 and 2014/0214500 A1 (which are both incorporated herein by reference in their entirety), which can monitor a given parking space for violations and automatically issue a citation electronically if a violation occurs. However, in some jurisdictions, such meters are not legally allowed to automatically issue electronic citations. Instead, a PEO must issue the citation and place the physical ticket or citation on the vehicle.

Thus, there is a need to make the citation process more efficient for parking enforcement personnel so that fewer violations go uncited and without increasing enforcement costs by adding more PEOs.

### SUMMARY

The present invention provides unique devices, systems and methods for managing parking monitoring and enforcement. In one aspect, a software application executing on a computing device (e.g. smart phone, tablet, laptop or personal computer) of a PEO communicates with a central computing system networked with a plurality of smart parking meters, directs the PEO to the location of a violation, and facilitates generation of a parking citation to be issued by the PEO, wherein the citation has at least some of the data fields prefilled. Thus, the PEO can issue more citations, issue a given citation more quickly and cover a larger territory.

In additional aspects, the software application can route the enforcement person to locations of parking violations according to certain parameters, including proximity to the enforcement person, length of violation, and density of violations in a given area (e.g. a specific lot or block).

The disclosure includes a parking enforcement system, comprising a plurality of parking meters, a central computing system and a parking enforcement officer computing device. Each of the parking meters is configured to monitor a parking event and notify the central computing system of a violation condition in a monitored space. The computing device includes a processor, memory and a graphical user interface. The computing device is networked with the central computing system. The computing device is configured to receive a violation data from the central computing system, display a list of parking violations on the graphical user interface, generate a parking citation with at least one data field of the parking citation prefilled, and clear a particular parking violation from the list of parking violations when the parking citation is issued for the particular parking violation.

A printing peripheral can be coupled to the computing device. The printing peripheral is configured to generate a paper copy of the parking citation.

The computing device can be configured to generate the parking citation with a parking enforcement officer's signature prefilled.

The computing device can be configured to present violation details in response to a user selection of the particular parking violation from the list of parking violations.

The computing device can be configured to include a picture of a portion of a vehicle that occupied the monitored space when a violation occurred corresponding to the monitored space. The picture can include the license plate of the vehicle.

The monitored space can be a location where parking is prohibited, a street space, a parking lot, parking ramp, parking garage, etc.

The computing device can be configured to remove a rejected particular parking violation from the list of parking violations.

The disclosure also includes a method of monitoring and enforcing parking requirements. The method includes obtaining an image of at least a portion of a vehicle occupying a parking space via a camera coupled to a parking meter which is monitoring the parking space, transmitting the image to a central computing system, and transmitting a violation data electronically from the central computing system to a parking enforcement officer computing device. A list of parking violations is displayed on the graphical user interface of the parking enforcement officer computing device. A particular parking violation is selected from the list of parking violations. The parking enforcement officer's computing device generates a parking citation with at least one data field of the parking citation prefilled. A notification that a parking citation has been printed for the particular parking violation can be transmitted to the central computing system by the parking enforcement officer computing device.

The list of violations can be sorted based upon global positioning system (GPS) data and proximity to the parking enforcement officer computing device. The list can also be sorted based upon time of violation, length of violation or any other metric or combination of metrics.

A list of handicapped parking events can be displayed on the graphical user interface of the parking enforcement officer computing device.

The signature of the parking enforcement officer can be captured and prefilled on a printed parking citation.

A paper parking citation can be printed via a printer coupled to the parking enforcement officer computing device.

The image from the central computing system can be transmitted to the parking enforcement officer computing device.

A thumbnail of the image for each parking violation can be included when displaying the list of parking violations on the graphical user interface of the parking enforcement officer computing device.

A notification that a parking citation has been rejected from the list of parking violations can be transmitted to the central computing system by the parking enforcement officer computing device.

The disclosure further includes a parking citation generation system. The system includes a parking meter coupled to a camera located such that the camera can obtain an image of a parking space being monitored by the parking meter, a central computing system networked with the parking meter, and a parking enforcement officer computing device networked with the central computing system. The parking enforcement officer computing device can be configured to receive a violation data from the central computing system and generate a parking citation with at least one data field of the parking citation prefilled.

The parking enforcement officer computing device can also be configured to notify the central computing system that a parking violation notice has been issued for a particular parking violation.

The above summary is not intended to limit the scope of the invention, or describe each embodiment, aspect, implementation, feature or advantage of the invention. The detailed technology and preferred embodiments for the subject invention are described in the following paragraphs accompanying the appended drawings for people skilled in this field to well appreciate the features of the claimed invention. It is understood that the features mentioned hereinbefore and those to be commented on hereinafter may be used not only in the specified combinations, but also in other combinations or in isolation, without departing from the scope of the present invention.

### BRIEF DESCRIPTION OF THE DRAWINGS

FIG. 1 is a diagram of various smart parking meter system components according to certain example embodiments.

FIG. 2 is a diagram of various components of an integrated parking enforcement system according to certain example embodiments.

FIGS. 3-12 are screen shots of a parking enforcement software application executing on a computing device according to certain example embodiments.

While the invention is amenable to various modifications and alternative forms, specifics thereof have been shown by way of example in the drawings and will be described in detail. It should be understood, however, that the intention is not to limit the invention to the particular example embodiments described. On the contrary, the invention is to cover all modifications, equivalents, and alternatives falling within the scope of the invention as defined by the appended claims.

### DETAILED DESCRIPTION

In the following descriptions, the present invention will be explained with reference to various exemplary embodiments. Nevertheless, these embodiments are not intended to limit the present invention to any specific example, environment, application, or particular implementation described herein. Therefore, descriptions of these example embodiments are only provided for purpose of illustration rather than to limit the present invention.

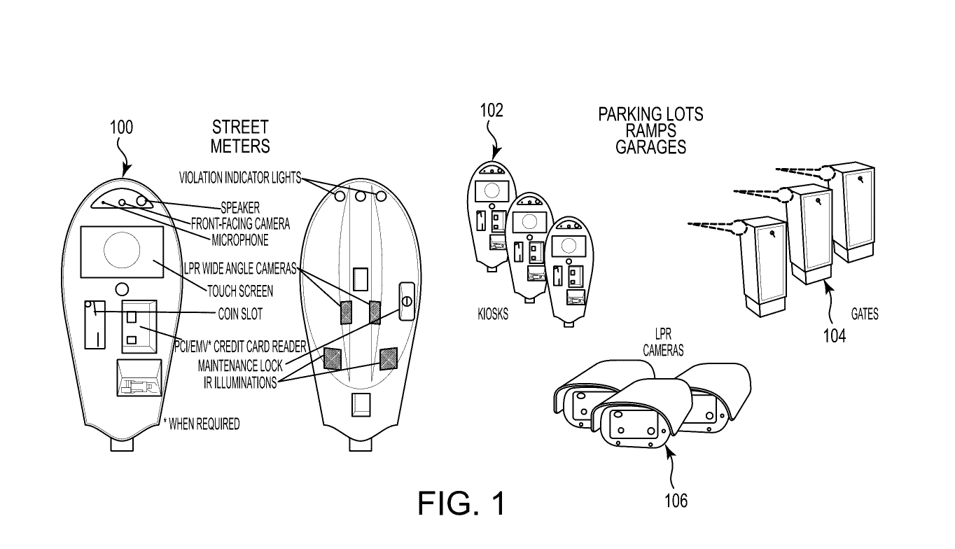

Referring to FIG. 1, various components of a smart parking system are shown. Smart parking meters 100, such as those disclosed in U.S. Pat. Pub. Nos. 2014/0214499 A1 and 2014/0214500 A1 (which are both incorporated herein by reference in their entirety), can be deployed adjacent to various parking spaces. Such smart meters provide for smart parking monitoring where the meters can sense the presence of a vehicle in a parking space, determine the identity of the vehicle, permit the parking user to pay for parking, determine parking violation notices, and other intelligent functions. Each of the meters 100 is also networked with a central or control computer for added control and functionality.

Each meter includes a processor and physical memory coupled to the microprocessor. A computer readable program code can be stored in the physical memory (e.g., random access memory, flash memory or hard-drive) of the meter. The computer readable program code is configured such that when executed by the microprocessor, the code causes the meter to perform the steps of the invention described herein.

The same or similar smart parking meter 100 can also be configured as a kiosk 102 and placed adjacent a parking lot or ramp. The kiosk 102 is coupled to gates 104 and/or license plate reading (LPR) cameras 106 to monitor parking events at a lot, ramp or garage and control the flow of vehicles into and out of the parking facility.

A kiosk 102 can also simultaneously function as a parking meter 100. A single kiosk or meter 102 can further be coupled to one or more LPR cameras 106 that each monitor individual parking spaces so that the single kiosk or meter 102 monitors multiple individual parking spaces or events.

Note that when the term meter is used throughout this application, such use should be understood to include both smart meters 100 and kiosks 102.

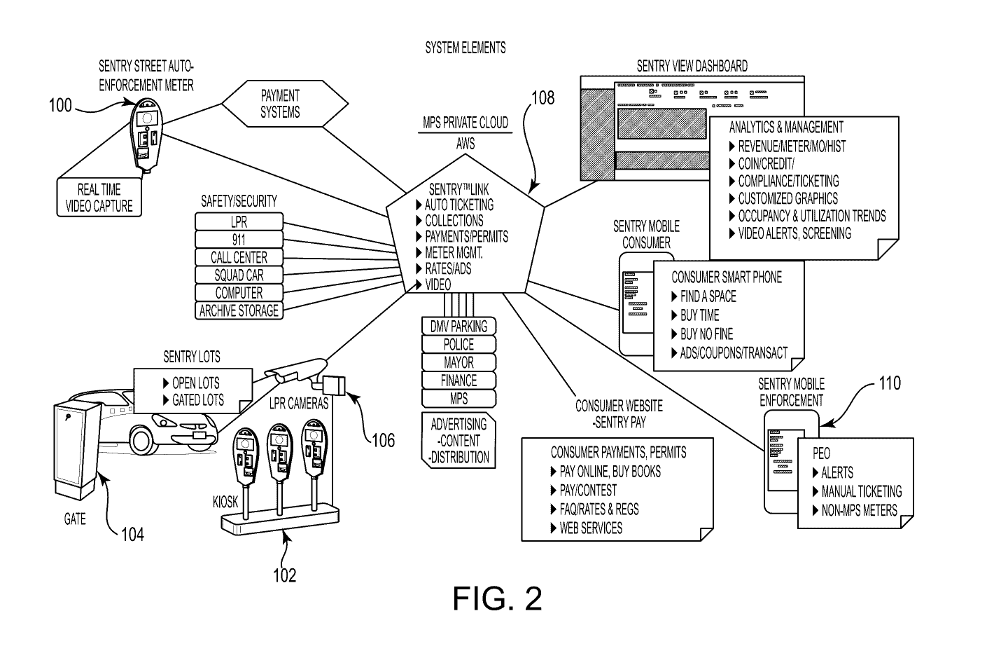

Referring to FIG. 2, each meter 100 and kiosk 102 is communicatively coupled to the so-called cloud computing system 108 via the internet or other wired or wireless connection. The cloud computing system can also be referred to as a central or control computer or server. The cloud 108 comprises one or more computer systems located remote from the meters and kiosks that is networked with the meters 100 and kiosks 102. The network can be wired or wireless, and the network can be either a private network (local area network or LAN) or a public network such as the world wide web (the Internet).

Computing devices 110 such as smart phones, tablet computers, laptops and personal computers can communicate with the meters and kiosks via the cloud server 108. The computing device 110 includes a microprocessor, physical memory coupled to the microprocessor, a graphical user interface, an input device (keyboard, mouse and/or touch-sensing display screen) and a network interface coupled to the microprocessor. The physical memory can be a non-transitory memory.

The network interface is configured to enable communication with a communication network (e.g. the Internet or World Wide Web), using a wireless connection (e.g. cellular such as LTE, Wi-Fi, etc.).

The memory in the computing device may include one or more non-volatile storage devices and/or one or more volatile storage devices (e.g., random access memory (RAM)).

The parking application can take the form of computer readable program code, which can be stored in the physical memory (e.g., random access memory, flash memory or hard-drive) of the computing device. The computer readable program code is configured such that when executed by the microprocessor, the code causes the PEO's computing device 110 to perform the steps of the invention described herein. In other embodiments, the invention can take the form of the computing device configured to perform steps described below. In still further embodiments, the invention can take the form of a system of networked smart meters/kiosks, a cloud server and a computing device. Other configurations will be apparent from the present disclosure.

Each smart meter is in communication with the cloud server. Using application program interfaces (API's), the parking application stored and executing on the PEO's computing device 110 can communicate with the cloud server, thereby communicating or exchanging parking data with the individual parking meters.

The ability of the parking enforcement application to communicate or exchange data in real time, or near-real time, with the actual parking meters provides the enforcement person with a means to quickly and efficiently monitor many parking meters and to efficiently issue parking citations.

Without communicating with the actual meters, either directly or via the cloud server, the parking enforcement software application would be subject to a severe latency problem (e.g. 24 hours or more) which would make it most likely impossible to issue a citation.

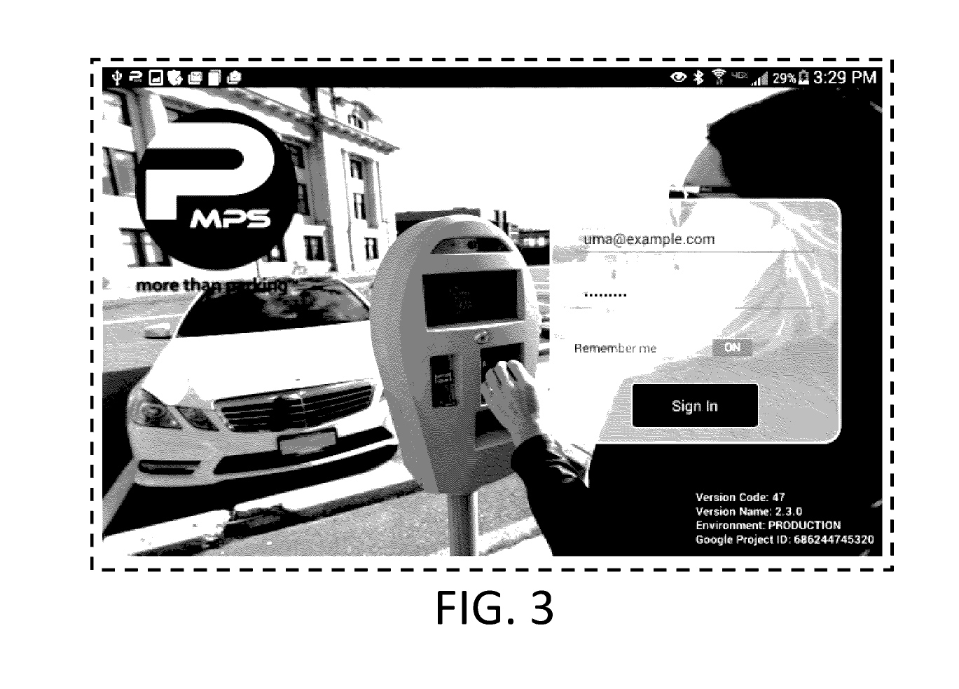

In use, the user (parking enforcement officer or PEO) launches the parking enforcement software application on their computing device 110. A login screen as shown in FIG. 3 is then displayed.

In alternative embodiments, the code for the parking enforcement software resides in the non-volatile memory of the central server. The PEO's computing device 110 remotely interfaces with the software via a web browser (e.g. using HTML 5 or equivalent). In this alternative, the parking enforcement software comprises a web application or web app.

The PEO must log into the software application immediately upon starting the application. This login step allows the cloud server 108 to control access, including recognizing the particular PEO using the parking application, the particular municipality and meter group(s) the PEO belongs to, and to register the PEO to receive approved violations automatically. The PEO usernames should be unique to an individual PEO. The PEOs can be set up or registered by administrative credentials through the cloud server.

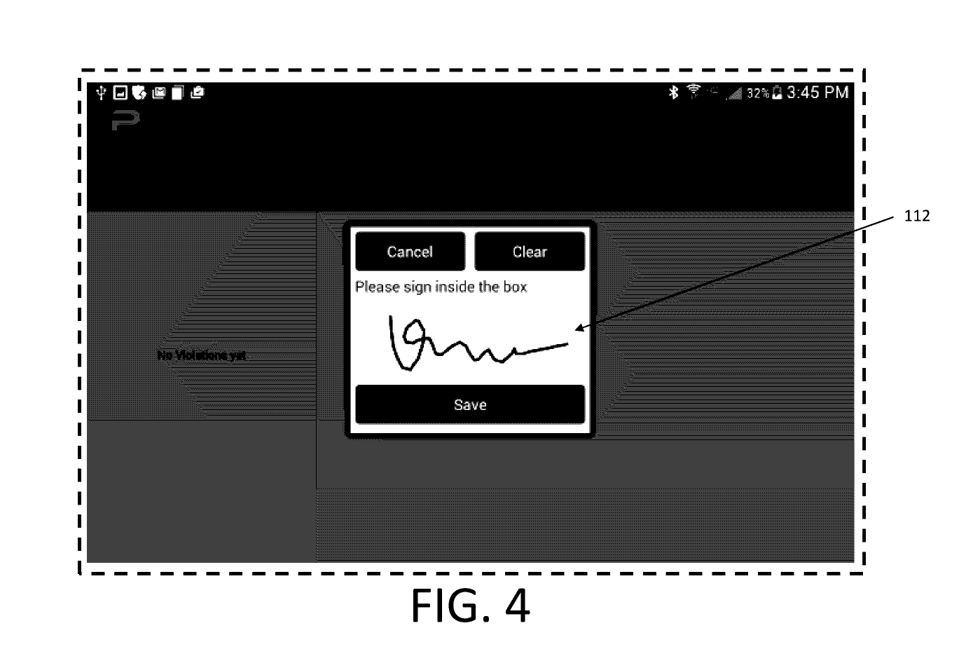

When logging in for the first time, the application prompts the PEO to input their signature into a box 112 as indicated in FIG. 4. This step allows the application to capture the PEO's signature and to print the signature on future parking citations. The signature can be input as an image file, portable document format or other conventional format. The image can be scanned from a live signature (including via image capture with a smartphone or tablet), or captured directly with a stylus on a screen of a computing device, or peripheral component thereto.

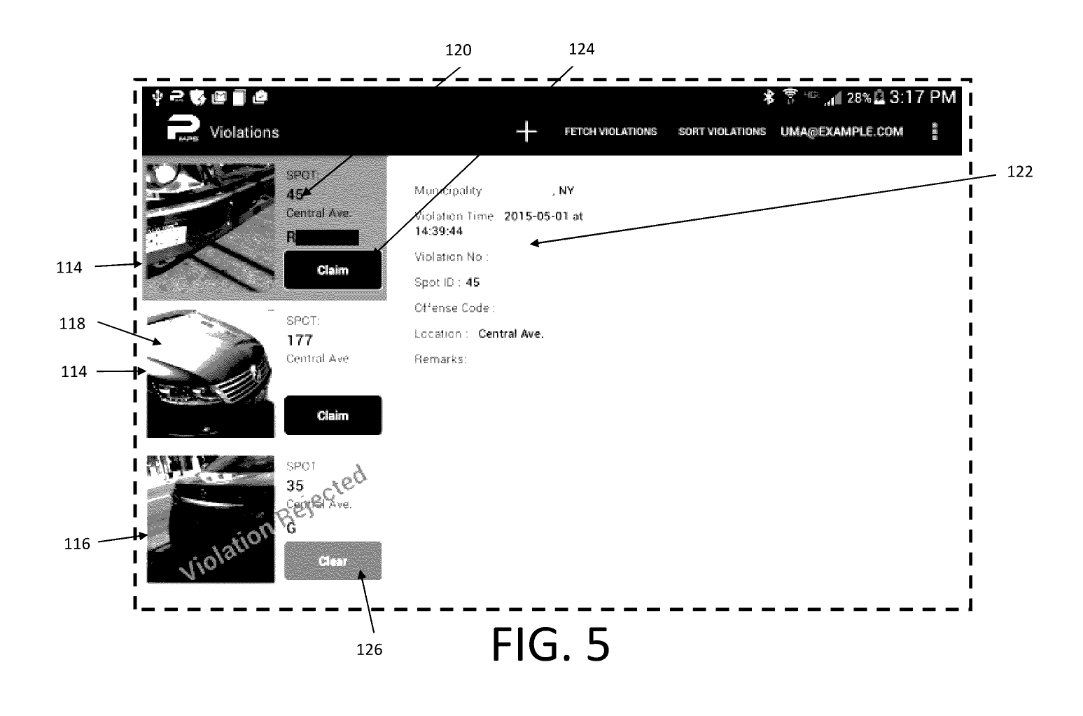

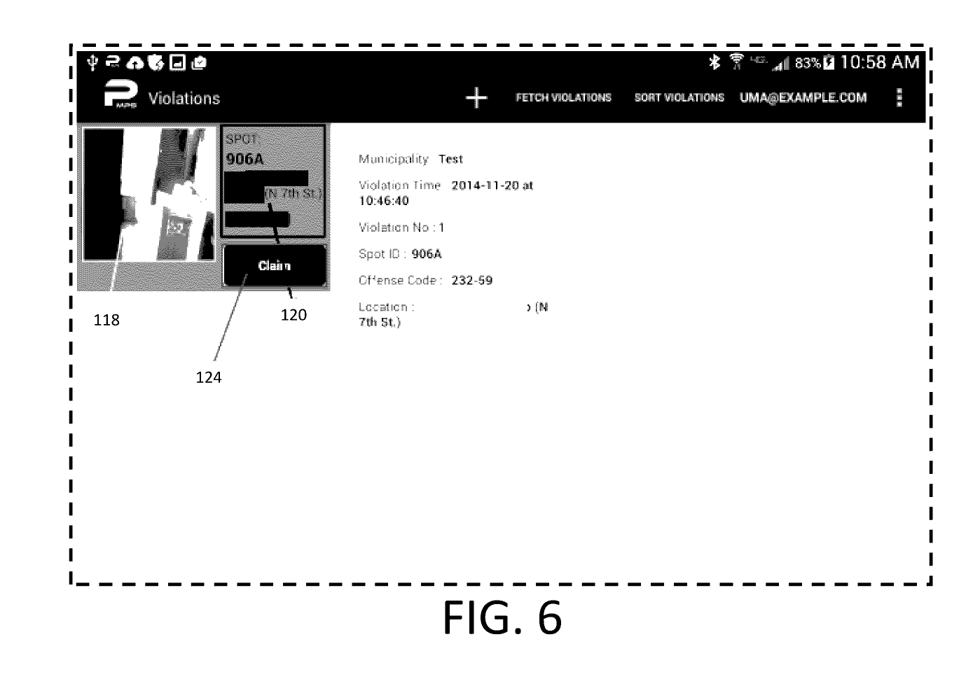

FIGS. 5 and 6 show the primary screen in the application—the “violation screen.” This screen is divided into three primary columnar sections.

First, the left columnar section presents a list of approved 114 and rejected 116 violations with an accompanying thumbnail image 118 of the vehicle in violation and details 120 for the relevant parking violation event. The PEO in this section can select (e.g., click or tap) the thumbnail image 118 to see a larger image. The PEO can also select the meter number text details 120 to “select” the violation and cause the middle section to show more details 122 for the selected violation event.

The violations in the left section are sorted automatically based on the time and GPS locality. Other sort schemes can also be employed. All approved violations have a “claim” button 124 which, as will be described later, can be used to print the parking citation (i.e. issue the parking ticket). Rejected violations are provided with a “Clear” button 126 to remove the violation event from the cloud server 108.

Second, the middle columnar section of FIG. 5 presents more details 122 about the selected violation in the left columnar section. These details include the violation number, when the violation was issued, reason for the violation (e.g. “Initial grace period exceeded”), violation time, location, municipality where violation occurred, and the particular parking space identification number or code.

Third, the right columnar section is used to actually complete the citation for a violation by filling-in the appropriate details and then printing the ticket. This right section is hidden until the violation is “claimed”. Claiming a violation means that the PEO indicates to the cloud server 108 that the given PEO will take care of issuing a citation (or clearing) this violation. Claiming or clearing the violation removes the violation from the violations list presented to other PEOs. Thus, the same violation cannot be accidentally processed more than once by two PEOs both issuing violation notices.

Rejected violations can be cleared from the violations list using the “Clear” button. This is to let the PEO know a violation has been rejected due to some reason.

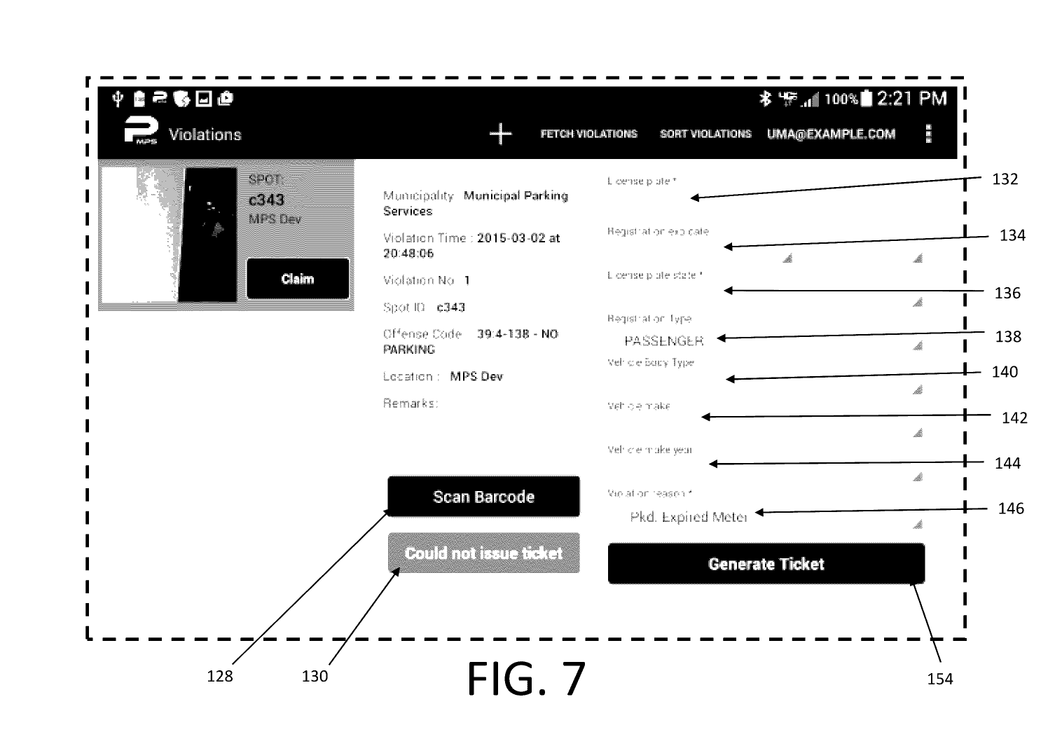

To process or issue a violation notice, the PEO clicks on the “claim” button. The software then presents the PEO with a screen like that shown in FIG. 7, wherein the right columnar section is now unhidden, and buttons for “scan barcode” 128 and “could not issue ticket” 130 are provided.

Details documented on the citation, including “License Plate” 132, “License plate state” 134, “Violation reason” 136, “Registration Type” 138, “Vehicle Body Type” 140, “Vehicle Make” 142, “Vehicle Model Year” 144 and “Violation Reason” 146 will be pre-filled if such data is available to the central server 108. This means that these data fields can be pre-filled using the license plate (or vehicle ID) data read by the smart meter 100, which is then matched up to records stored in memory by the central server, or from a database of vehicle records accessed by the central server 108. The violation determination is made by the meter 100, kiosk 102 or the central computing system 108.

For example, the meter 100 can read the vehicle's license plate and provide the vehicle plate data to the PEO's software application in order to pre-fill portions of the parking citation. Using the plate data relayed by the meter, the cloud server can also interface with vehicle registration records databases in order to pre-fill the vehicle owner information as well. The “violation reason” is the description of the violation determined by the meter or server that caused the violation notice to be sent to the PEO's computing device.

One reason for a violation to be flagged is that the parker remained parked after their purchased parking time expired. Another reason is that payment for the parking event was not remitted within an allowed grace period following the beginning of a parking event. A further reason is that the person parked their vehicle in a location designated as illegal or no-parking. An example of this latter scenario is that a meter, or remote camera coupled to a meter or kiosk, is configured to monitor an area of no-parking adjacent to a fire hydrant. The meter will note the violation immediately upon a vehicle parking in the designated no-parking space. The PEO is notified of the violation as described herein and the specific reason or code violated is noted in the software application so that the corresponding ticket can be issued.

The PEO next scans in the bar code (or QR code) from the vehicle's license plate, if a barcode is present, using the “scan barcode” option 128. The PEO's computing device can include a camera, scanner or other optical recognition means to allow the barcode to be scanned. The meter's identification code can also be manually entered by the PEO, if desired. This step is not applicable in jurisdictions where vehicles do not have bar codes. Alternatives, such as radio frequency identification (RFID) chips on the vehicles and RFID chip readers in the PEO computing devices 110 can be provided in certain alternatives to optical reading means such as bar codes and QR codes.

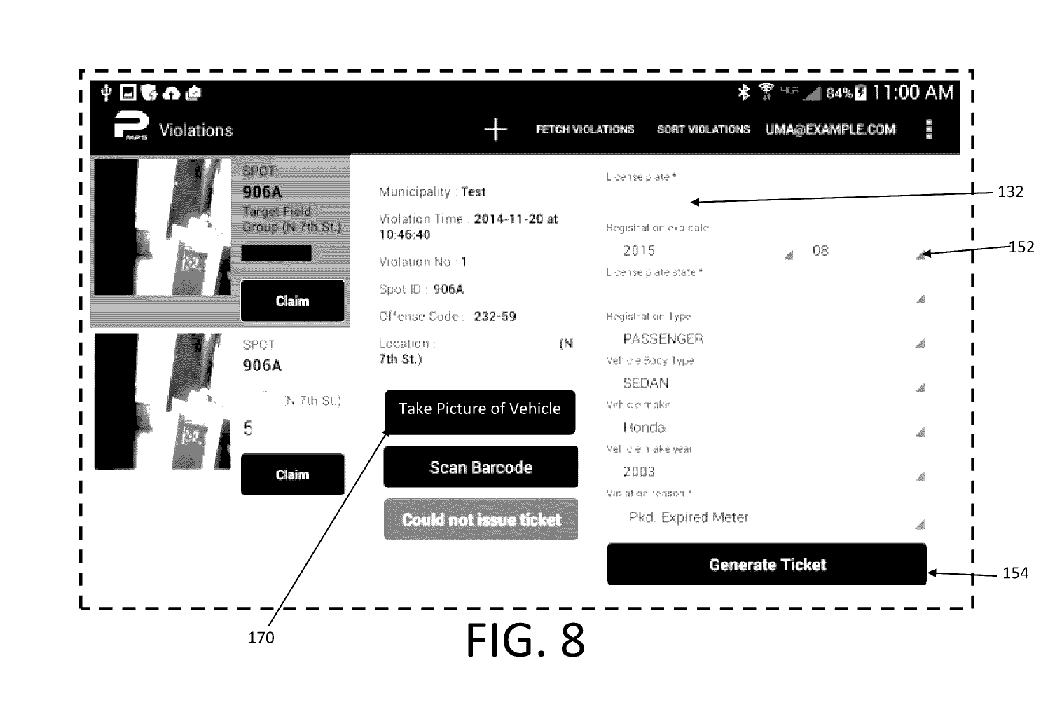

After the scanning, the PEO is automatically presented with a violation details screen as shown in FIG. 8. This allows the PEO to confirm that some or all of the pre-filled violation data corresponds to the vehicle and violation event. For example, the PEO can double check the vehicle's license plate 132 noted in the violation screen reflects the correct vehicle license plate. The PEO can use the drop-down menus 152 to select and manually edit the vehicle's details such as make, model, color, body type, etc.

A given municipality can dictate the bare minimum number of fields that must be accurately populated in order to print a ticket in that municipality.

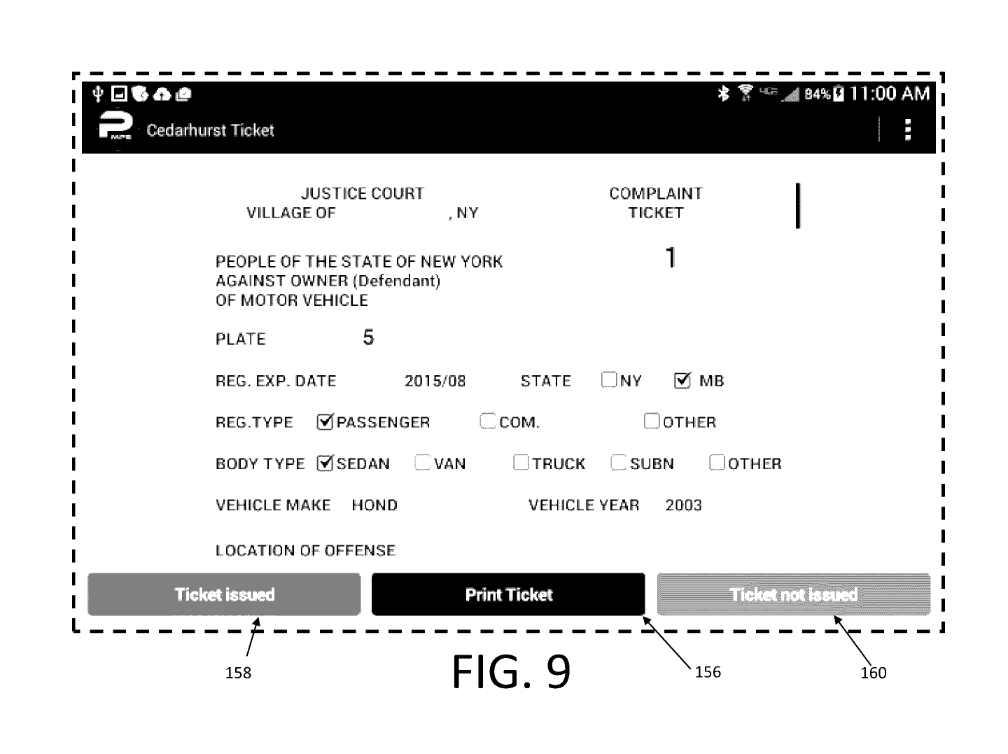

The PEO next “generates” the ticket by selecting the “generate ticket” option 154. In response, the software application displays the generated ticket on the screen as shown in FIG. 9 on the PEO's computing device. The PEO can then select the “print ticket” option 156, which causes a printer peripheral to print the physical parking citation. The printer is coupled to the computing device by either a wired or wireless connection (e.g. Bluetooth). Any number of commercially available small printers can be used. Many can be worn by the PEO, or the printer can be located in or on the PEO's vehicle. The printer can also be included in common or adjoined housing with the PEO's computing device.

Shortly after selecting “Print Ticket” 156 the mobile printer will print the physical citation. The citation is then placed by the PEO on the appropriate place on the vehicle.

After the ticket is printed, the PEO selects the “ticket issued” option 158. This means that the violation has been fully processed. The status is reported to the cloud server 108, which can then track the payment status of the violation. The payment or non-payment status can be reported to the law enforcement authorities by interfacing with the appropriate law enforcement records databases or by sending a notification to an email inbox for the law enforcement authority.

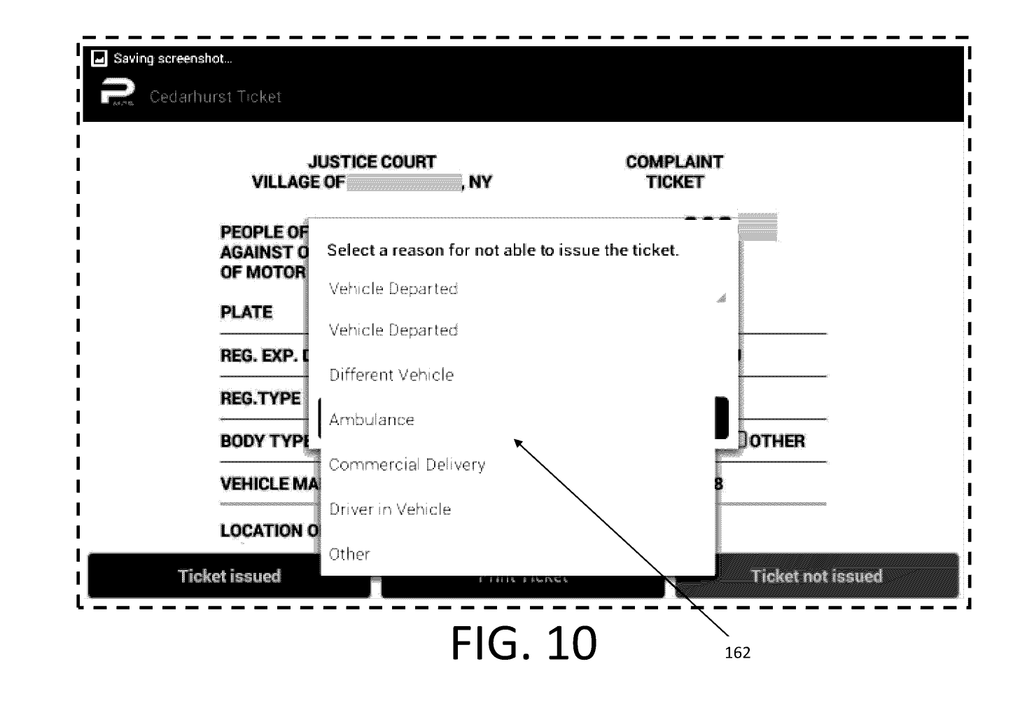

Prior to selecting the “ticket issued” option 158, the PEO can select the “ticket not issued” option 160 to terminate the ticket issuing process. The PEO can be prompted to select from a menu of reasons 162 for selecting this option as shown in FIG. 10.

The PEO's software application returns to the primary or main violations page (FIG. 5) after one of the ticket issued/not issued options is selected.

Processed violations are removed from the list in the left columnar section of the primary or main violations screen, FIG. 5.

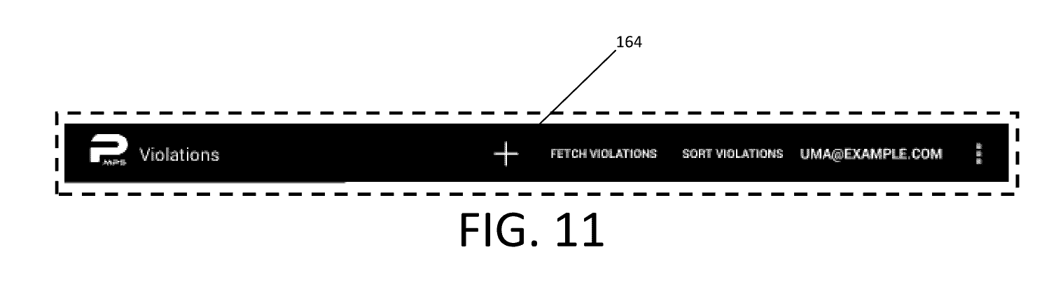

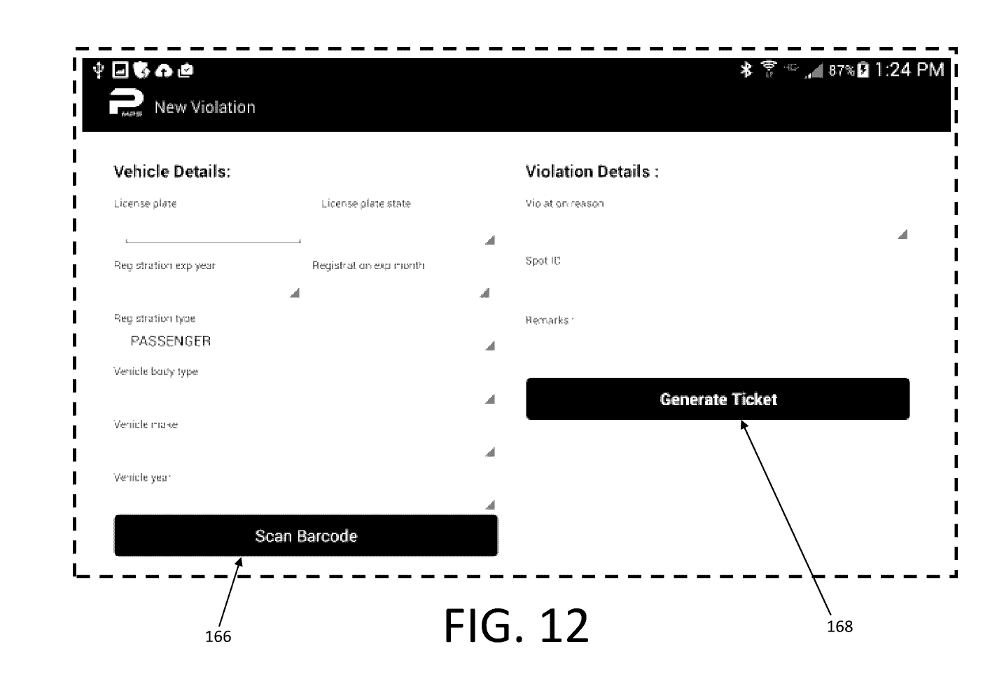

Parking violations can also be initiated manually. To do this, the PEO clicks on the “+” icon 164 on the action bar of the main screen. This bar is replicated in FIG. 11 for convenient reference. The selection of this icon 164 then opens the “new violation” screen as shown in FIG. 12.

The PEO then clicks the “scan barcode” 166 option to get information fast from the vehicle barcode. The PEO fills in the license plate and other violation details by selecting on each of the relevant fields on the right half of the screen and then inputting the requested information. Selecting the “generate ticket” 168 option takes the PEO to the ticket printing screen (FIG. 9) and the ticketing process then proceeds as described above.

The software also is configured to include the function allowing the PEO to take an image of the violating vehicle manually and include the image on the citation. Referring to FIG. 8, the PEO selects the option to “Take Picture of Vehicle” 170. Alternatively, the image of the vehicle taken by the camera coupled to the meter or kiosk can be automatically inserted into the citation.

The PEO's location can be tracked with a GPS receiver/decoder coupled to the computing device 110.

The parking software application can also be integrated into other computing systems, such as integrated vehicle operation systems. For example, the present software application can be integrated into the vehicle's control and/or navigation systems since that is a mobile computing platform that is typically connected to the Internet. The integration with such vehicle system can be direct via storing of the software in the system's memory, or indirectly via smartphone interfaces such as Apple's CARPLAY and Google's ANDROID AUTO where the software resides on the PEO's computing device.

In an additional aspect, a person parking at a meter or in a parking facility can select the option to park with handicapped privileges when interacting with the meter/kiosk. This often allows under local municipal rule and statutes for the handicapped person to park without a fee or for a longer time period or other factors that non-handicapped persons do not receive. However, the use of the handicapped option can be inappropriately used by the parker. Thus, the software application can present the PEO with a notification of handicapped parking persons in order to verify that the required handicapped authorizations are displayed on or in the vehicle.

In a further aspect, the person parking can request help or assistance when interacting with the meter/kiosk. The software application is configured to present the nearest PEO, or a designated PEO, with a notification of the assistance/help request. A video conference can be established between the assistance requester and the PEO via the PEO software linking to the meter/kiosk. The meter or kiosk includes an integrated video conferencing camera, microphone and speakers. The PEO's computing device 110 also has videoconferencing cameras, microphones and cameras typical of mobile computing devices and laptop computers.

Note that this application and the appended figures reference certain trademarks and copyrights belonging to Municipal Parking Services, Inc., including the trademark SENTRY and the MPS logo. No rights to use any of these copyrights and trademarks are either express or implied by their mention in this patent application. The mention of these copyrights and trademarks is merely for illustrative purposes.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

What is claimed is:

1. A parking enforcement system, the parking enforcement system comprising a plurality of parking meters, each of the parking meters configured to monitor a parking event and notify a central computing system of a violation condition in a monitored space, the system comprising:
a computing device, the computing device comprising a processor, memory and graphical user interface, wherein the computing device is networked with the central computing system, and wherein the computing device is configured to:
receive a violation data from the central computing system;
display a list of parking violations on the graphical user interface;
generate a parking citation with at least one data field of the parking citation prefilled; and
clear a particular parking violation from the list of parking violations when the parking citation is issued for the particular parking violation.

2. The system of claim 1, wherein the prefilled parking data on the parking citation is a vehicle license plate data.

3. The system of claim 1, further comprising a printing peripheral coupled to the computing device, wherein the printing peripheral is configured to generate a paper copy of the parking citation.

4. The system of claim 1, wherein the computing device is further configured to generate the parking citation with a parking enforcement officer's signature prefilled.

5. The system of claim 1, wherein the computing device is further configured to present violation details in response to a user selection of the particular parking violation from the list of parking violations.

6. The system of claim 1, wherein the violation details include violation number, violation time, and parking space identification data corresponding to the particular parking violation.

7. The system of claim 1, wherein the computing device is further configured to include a picture of a portion of a vehicle that occupied the monitored space when a violation occurred corresponding to the monitored space.

8. The system of claim 7, wherein the picture includes the license plate of the vehicle.

9. The system of claim 1, wherein the monitored space is a location where parking is prohibited.

10. The system of claim 1, wherein the computing device is further configured to remove a rejected particular parking violation from the list of parking violations.

11. A method of monitoring and enforcing parking requirements, the method comprising:
obtaining an image of at least a portion of a vehicle occupying a parking space via a camera coupled to a parking meter which is monitoring the parking space;
transmitting the image to a central computing system;
transmitting a violation data electronically from the central computing system to a parking enforcement officer computing device;
displaying a list of parking violations on the graphical user interface of the parking enforcement officer computing device;
selecting a particular parking violation from the list of parking violations;
generating by the parking enforcement officer computing device a parking citation with at least one data field of the parking citation prefilled; and
transmitting to the central computing system by the parking enforcement officer computing device a notification that a parking citation has been printed for the particular parking violation.

12. The method of claim 11, further comprising sorting the list of violations based upon global positioning system (GPS) data and proximity to the parking enforcement officer computing device.

13. The method of claim 11, further comprising displaying a list of handicapped parking events on the graphical user interface of the parking enforcement officer computing device.

14. The method of claim 11, further comprising capturing the signature of the parking enforcement officer and prefilling the signature on a printed parking citation.

15. The method of claim 11, further comprising printing a paper parking citation via a printer coupled to the parking enforcement officer computing device.

16. The method of claim 11, further comprising transmitting the image from the central computing system to the parking enforcement officer computing device.

17. The method of claim 11, further comprising including a thumbnail of the image for each parking violation when displaying the list of parking violations on the graphical user interface of the parking enforcement officer computing device.

18. The method of claim 11, further comprising transmitting to the central computing system by the parking enforcement officer computing device a notification that a parking citation has been rejected from the list of parking violations.

19. A parking citation generation system comprising:
a parking meter coupled to a camera located such that the camera can obtain an image of a parking space being monitored by the parking meter;
a central computing system networked with the parking meter;
a parking enforcement officer computing device networked with the central computing system, which is configured to receive a violation data from the central computing system and generate a parking citation with at least one data field of the parking citation prefilled.

20. The system of claim 19, wherein the parking enforcement officer computing device is further configured to notify the central computing system that a parking violation notice has been issued for a particular parking violation.
